(19) United States
(12) Patent Application Publication
(10) Pub. No.: US 2012/0134146 A1
(43) Pub. Date: May 31, 2012

(54) LIGHTING APPARATUS

(76) Inventor: Andrew Smith, Truro (GB)

(21) Appl. No.: 13/376,638

(22) PCT Filed: Jun. 10, 2010
(86) PCT No.: PCT/GB2010/050974

§ 371 Date: Jan. 25, 2012

(30) Foreign Application Priority Data
Jun. 10, 2009 (GB) 0909916.9
Jun. 10, 2009 (GB) 0909936.7
Jun. 10, 2009 (GB) 0909942.5

(51) Int. Cl. F21S 4/00; F21V 15/015; F21V 7/04

(52) U.S. Cl. 362/225; 362/350; 362/364

(57) ABSTRACT

A lighting apparatus (1) with a housing (2), two parallel elongate lighting cells (5a, 5b) and a concave reflector (6) configured to focus light emitted from the two lighting cells (5a, 5b). The lighting cells (5a, 5b) are movable with respect to one another and with respect to the reflector (3), thereby to alter the spread and/or direction of the emitted light. The housing includes removable end caps (3) each with a receptacle (33) that receive the end portion (22) of the housing (2) and a clip (35) configured to connect the end cap (3) to the housing (2). The reflector (6) includes spaced brackets (60) and a resilient reflective sheet (61) received and retained by the brackets (60).

This invention relates generally to lighting apparatus, reflectors for use in lighting apparatus and a kit of parts useful in configuring lighting apparatus for different applications. More specifically, although not exclusively, this invention relates to modular lighting apparatus designs that enable adjustment of the beam spread, direction and/or flow of emitted light for illuminating an area in an effective and/or uniform manner and facilitate the configuration of lighting apparatus and their associated reflectors with bespoke lengths, sizes and shapes.

The ever increasing cost of electricity has created a demand for more efficient lighting systems. As a result, lighting systems are often designed and/or installed in a bespoke manner, wherein they are tailored to provide the most cost effective solution for the specific application in question. This has created a need for flexible and/or adaptable lighting apparatus, for example which are capable of adjustment to optimise the light distribution for varying environmental conditions.

U.S. Pat. No. 6,945,671 discloses a lighting apparatus in which the position of a twin lighting cell is adjustable relative to the base of a reflector to adjust the beam width. The lighting cell is mounted to a support bracket which allows for linear slideable adjustment in a single direction toward or away from the base of the reflector, thereby to decrease or increase the spread of the beam. Similarly, DE1641917U discloses a lighting apparatus in which two elongate lighting cells are mounted in a parallel relationship to a support which is rotatably mounted with respect to the reflector. Whilst these arrangements provide a degree of control of the dispersion characteristics of the light emitted from the apparatus, it is limited to the adjustment of the spread and/or focus of the beam.

WO9205388 discloses a further lighting apparatus with a pair of lamp and reflector assemblies in which each lamp is mounted into a series of comb slots which permit adjustment in two orthogonal directions relative to its respective reflector. This further dimension of adjustability permits a further degree of control of the direction of the emitted light since the lamp may be offset from the centreline of the reflector, which provides more adjustability. This arrangement is beneficial where, for example, the lighting apparatus is to be mounted adjacent a wall, whereby the position of the lamp may be such that more light is emitted away from the wall to illuminate the room more effectively. However, adjustment of the position of the lamp results in a change in direction of the entire emitted beam, which may not be ideal in some circumstances.

It is therefore a general non-exclusive object of the invention to provide an improved lighting apparatus, for example which provides improved adjustability and/or at least mitigates the issues associated with the prior art. It is a first more specific non-exclusive object of the invention to provide a lighting apparatus which provides variable adjustment of the beam spread, direction and/or flow of emitted light for illuminating an area in an effective and/or uniform manner.

It is a second specific non-exclusive object of the invention to provide a lighting apparatus that facilitates the fabrication of various sizes to accommodate various lengths of lighting cells and/or that accommodates various circumstances.

It is a third specific non-exclusive object of the invention to provide a reflector design that facilitates the fabrication of various sized reflectors to accommodate various lengths of lighting cells and/or which accommodate various circumstances.

Accordingly, one aspect of the invention provides a lighting apparatus comprising two parallel elongate lighting cells and a concave reflector configured to focus, in use, light emitted from the two lighting cells, wherein one of the lighting cells is movable with respect to the other lighting cell, thereby to alter the spread and/or direction of the emitted light.

A second aspect of the invention provides a lighting apparatus comprising a first connector for connecting to and holding a first elongate lighting cell, a second connector for connecting to and holding a second elongate lighting cell and a concave reflector for focusing light emitted from lighting cells connected, in use, to the connectors, wherein the first connector is movable with respect to the second connector, thereby to alter the spread and/or direction of light emitted from lighting cells connected to and held by the connectors.

The provision of a pair of lighting cells or connectors, one of which is movable with respect to the other provides a greater degree of control of the spread and/or direction of illumination. Thus the apparatus facilitates more flexible adaptation of the dispersion of emitted light.

Preferably, the one lighting cell or the first connector is also movable with respect to the reflector. More preferably, each lighting cell or connector is independently movable with respect to the other and/or with respect to the reflector. This arrangement provides an even greater degree of flexibility in adapting the dispersion of emitted light.

At least one of the lighting cells or connectors may be movable toward and/or away from a portion, e.g. a base, of the reflector and/or may be movable, in use, between a first position, e.g. in which the lighting cells or connectors are side by side, and a second position, e.g. in which one of the cells is above the other. It will be appreciated by those skilled in the art that these two configurations provide very different dispersion characteristics.

The lighting cell or the first connector may be movable along a guide, e.g. of the apparatus, for example it may be connected to, be mounted on, incorporate or be incorporated within a carrier which may be movable along the guide.

Preferably, the carrier comprises a first carrier and the apparatus may comprise a further or second carrier which may include the further or second connector and/or wherein each lighting cell or connector may be connected to or mounted on the further or second carrier. The further or second carrier may be independently movable with respect to the carrier or first carrier and/or with respect to the reflector.

The guide may be curved, for example it may include a curved portion or section, e.g. extending substantially along at least a portion of the reflector, and/or a straight portion or section, e.g. extending toward and/or away from a base of the reflector. Preferably, each lighting cell or connector is movable, e.g. independently movable, along the or a respective guide, for example via a respective carrier. The apparatus more preferably includes two guides, each of which may include a curved portion, e.g. which substantially follows the curve of the reflector, and/or one or both of which may include a straight portion, e.g. which extends toward and/or away from a base of the reflector.

The guide is preferably configured for stepwise adjustment of the lighting cell or first and/or second connectors, for example the lighting cell or connector or carrier may comprise a portion shaped to cooperate with a portion of the guide, e.g. one of two or more portions thereof, to provide the stepwise adjustment. In one class of embodiments, one of the lighting cell or connector or carrier and the guide comprises a projecting portion, e.g. a projection, which is configured to cooperate with a recess or depression in the other, e.g. one of a plurality of recesses or depressions in the other, of the lighting cell or connector or carrier and the guide. For example, the guide may comprise a slot or groove within which at least a portion of the lighting cell or connector or carrier may be received, e.g. slideably received. The guide or slot or groove may include one or more recesses or depressions therealong, for example which are spaced and/or configured to cooperate with a projecting portion or projection of or on the lighting cell or connector or carrier. Alternatively, the guide or slot or groove may include projecting portions or projections therealong, for example which are spaced and/or configured to cooperate with a recess or depression of or in the lighting cell or connector or carrier.

Advantageously, the apparatus may include a resilient biasing means, for example a resilient member or device such as a spring, which may be configured to bias, in use, the cooperating portions of the lighting cell or connector or carrier and the guide toward one another. The lighting cell or connector or carrier or the guide may incorporate the resilient biasing means. Preferably, the lighting cell or connector or carrier includes a shaft along which the resilient biasing means acts to urge the cooperating portions together. For example, the shaft may be receivable or received within the guide or slot and/or within the resilient member and/or include a stop against which the resilient member abuts. The resilient member may include an abutment for urging the cooperating portion of the lighting cell or connector or carrier against the cooperating portion of the guide. Additionally or alternatively, the resilient abutment may incorporate the or a further cooperating portion for cooperating with the or a further cooperating portion of the guide.

The connector or carrier may comprise an electrical and/or mechanical connector, which may be configured to connect, e.g. electrically and/or mechanically connect, to or with and/or hold, in use, the lighting cell.

The apparatus may further comprise at least one end part, for example to which the guide is mounted or which end part includes the guide. Preferably, the apparatus comprises a pair of opposed end parts, wherein at least one of the connectors or the ends of at least one of the lighting cells or connectors may be mounted or is mountable, e.g. movably or slideably mounted or mountable, to a respective end parts. Both connectors or ends of the lighting cells may be mounted or mountable, e.g. movably or slideably mounted or mountable, to the end part or parts, e.g. the same end part or parts. The or each end part may be mounted or mountable to or in or may be at least partially contained or containable within an end cap of the apparatus.

The apparatus may further comprise a housing, for example with an end portion and/or an end cap which may have a receptacle, e.g. configured to receive the end portion of the housing, and/or a clip, e.g. configured to connect the end cap to the housing. The clip may be configured to be inserted, in use, into or through an opening of the end cap, e.g. to engage an engaging feature of the end portion.

A third aspect of the invention provides a kit of parts for assembly into a lighting apparatus, the kit comprising a housing with an end portion, an end cap with a receptacle configured to receive the end portion of the housing and a clip configured to connect the end cap to the housing, wherein the clip is configured to be inserted, in use, into or through an opening of the end cap to engage an engaging feature of the end portion.

A fourth aspect of the invention provides a lighting apparatus assembled from the aforementioned kit. The lighting apparatus may comprise the or a housing with the or an end portion, the or an end cap with a receptacle within which the end portion of the housing is received and the or a clip received within an opening of the end cap, which clip engages an engaging feature of the end portion.

The use of a housing with end caps provides flexibility in configuring lighting apparatus of various lengths for different applications. The provision of a separate clip which is inserted into or through an opening of the end cap to engage the housing provides a simple fastening means which separates the fastening step from the positioning step. This is particularly useful where the assembly is not intended to be capable of disassembly.

Preferably, the clip is configured to permanently or irreversibly engage the engaging feature of the end portion. For the avoidance of doubt, the term “permanently or irreversibly engages” means that the end cap and housing may only be disengaged by damaging at least a portion of at least one of the clip, the end cap and/or the housing.

More preferably, the receptacle comprises a wall, for example an inner wall, which wall is preferably configured or shaped to at least partially obscure the clip when the clip is engaged with the engaging feature, e.g. to prevent or at least inhibit access to or removal of the clip. The receptacle may also comprise a further wall, for example opposite the wall, which further wall may also be configured or shaped to at least partially obscure the clip when the clip is engaged with the engaging feature. The end portion and/or the engaging feature may be received or receivable between the walls. The opening is preferably configured to be adjacent the engaging feature, for example to permit the clip to engage, in use, the engaging feature, e.g. between the opposed walls, when the clip is inserted into the opening. The apparatus may further comprise seal, for example which is located or configured to be located between one of the walls, e.g. the inner wall, and the end portion of the housing which may be configured to provide a dust seal.

The clip may resiliently engage the engaging feature. For example, the clip may comprise a resilient portion and/or a projection and/or the engaging feature may comprise a recess or aperture, wherein the projection may be configured to resiliently engage the recess or aperture, e.g. the projection may be resiliently biased toward or into the recess or aperture such as by the resilient portion. The resilient portion may advantageously comprise a curved portion and/or the projection may comprise a barb. The opening may be shaped and/or configured to urge or bias the resilient portion, for example straighten the curved resilient portion such as by virtue of the shape and/or configuration of the projection or barb, upon insertion of the clip therein and/or to snap the projection or barb into engagement with the engaging feature, e.g. into the recess or aperture.

Additionally or alternatively, the opening may be shaped and/or configured such that the clip is flush with a portion of the end cap which surrounds the opening when the clip is engaged with the engaging feature. This feature provides a clear indicator to a person that the clip is in place. This feature is particularly useful where the clip comprises a flat end portion, which end portion is preferably flush with the aforementioned surrounding surface when the clip is engaged with the engaging feature. For example, where the clip comprises a curved resilient portion, the flat end portion could be configured to provide an indicator of the correctness of the clip's installation. More specifically, the flat portion could be configured to be at an angle with respect to the surrounding surface if the projection or barb is not properly engaged with the engaging feature.

The housing may comprise an extrusion and/or channel member, e.g. to which at least one end cap may be mountable or connectable or securable.

A fifth aspect of the invention provides a housing for use in the aforementioned apparatus or kit of parts. The housing preferably includes an end portion with engaging means in the form of at least one recess or aperture.

A sixth aspect of the invention provides an end cap for use in the aforementioned apparatus or kit of parts. The end cap preferably includes a receptacle configured to receive the end portion of the housing and an opening for receiving the clip.

A seventh aspect of the invention provides a clip for use in the aforementioned apparatus or kit of parts. The clip is preferably configured to connect the end cap to the housing and/or to be inserted, in use, into or through the opening of the end cap to engage the engaging feature of the end portion of the housing.

The apparatus or kit may further comprise a reflector.

The reflector may comprise one or more, e.g. two or more, spaced reflector brackets and/or a resilient reflective sheet which may be received by the brackets and/or have first and second major surfaces. Each bracket may have a concave cradle surface and/or a flange, e.g. extending inwardly from one or each end of the cradle surface. The flanges of each bracket may engage respective portions of the longitudinal edges of the sheet, for example to hold the sheet in a flexed condition, e.g. with the first major surface thereof in abutment with the cradle surface of the respective bracket, such as to provide a concave reflective second major surface.

An eighth aspect of the invention provides a reflector for use in a lighting apparatus, the reflector comprising two or more spaced reflector brackets and a resilient reflective sheet received by the brackets and having first and second major surfaces, each bracket having a concave cradle surface and a flange extending inwardly from each end of the cradle surface, wherein the flanges of each bracket engage respective portions of the longitudinal edges of the sheet to hold the sheet in a flexed condition with the first major surface thereof in abutment with the cradle surface of the respective bracket, thereby to provide a concave reflective second major surface.

The provision of independent brackets, e.g. with concave cradle surfaces, each of which brackets has opposed inwardly extending flanges, provides flexibility in assembling bespoke standalone reflectors. For example, the reflector may include a relatively rigid reflective sheet material, requiring reduced spacing between adjacent brackets, and/or lighting cells of a non-standard length for some applications, again having different spacing requirements.

The reflector may further comprise an alignment means, for example an alignment member, which may cooperate with or engage the two or more brackets. In some embodiments, the alignment member comprises one or more, e.g. two, alignment rods which may extend through and/or be at least partially received by each bracket. Advantageously, one or more of the brackets may comprise an end plate, for example which may be configured to be connected or secured to a housing. The end plate may include a fastening or locking formation configured to cooperate with the alignment means or member, e.g. to retain it in place.

The two or more brackets may comprise three or more brackets, for example four brackets. Preferably, one or more of the brackets is substantially rigid and/or includes a mounting portion or surface, for example a base which may include the mounting surface and/or may include a fastening formation and/or a hole which may be threaded and/or configured to receive a fastener therethrough.

A ninth aspect of the invention provides a lighting apparatus comprising the reflector. The apparatus may further comprise one or more, e.g. two, lighting cells, which may be parallel and/or elongate. The reflector may be configured to focus, in use, light emitted from the two or both lighting cells, e.g. simultaneously. One of the lighting cells may be movable with respect to the other lighting cell, e.g. thereby to alter the spread and/or direction of the emitted light.

The lighting apparatus or kit may further comprise a cover, for example a dust cover, which may be retained or retainable on, over or against the housing by retaining means, for example magnetic retaining means such as a magnet that may cooperate with a ferrous material of the housing.

Further aspects of the invention provide a kit of parts for assembly into a lighting apparatus according to any one of the first, second, eighth and ninth aspects of the invention.

Embodiments of the invention will now be described by way of example only with reference to the accompanying drawings in which:

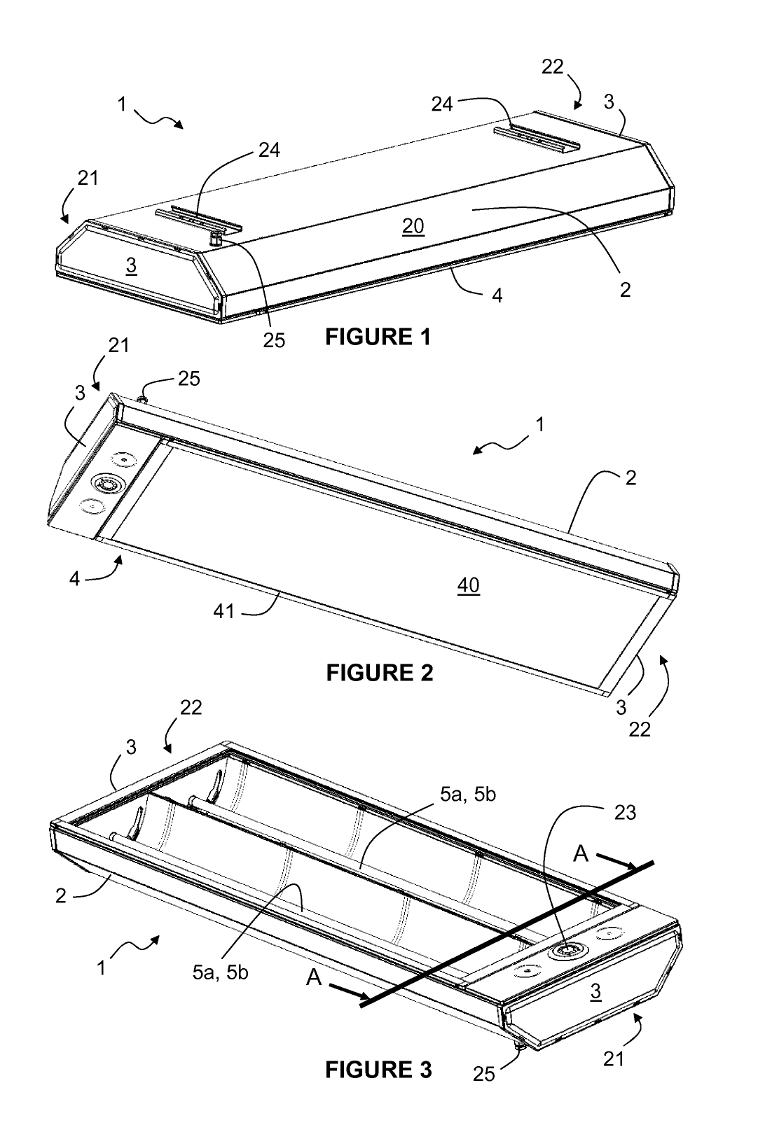

FIG. 1 is a perspective view from above of one embodiment of the lighting apparatus according to the invention;

FIG. 2 is a perspective view from below of the lighting apparatus;

FIG. 3 is a perspective view from below of the lighting apparatus with the transparent dust cover removed.

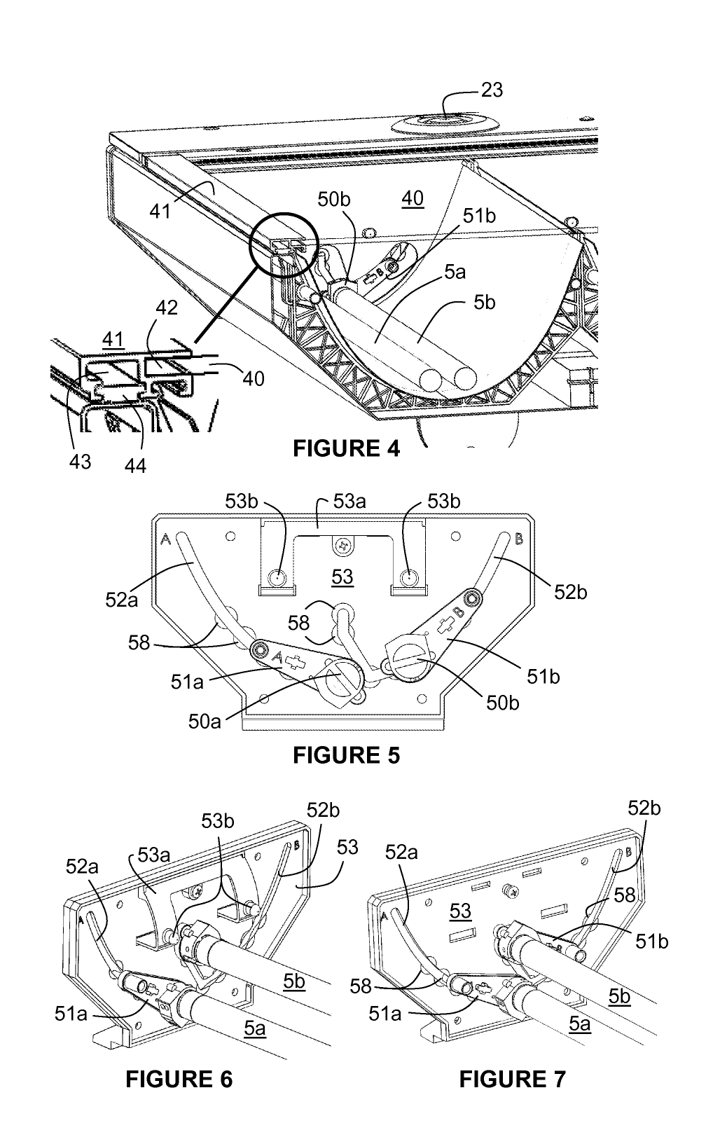

FIG. 4 is a partial perspective section view along line A-A of FIG. 3 showing the lighting cells in a first side by side position;

FIG. 5 is a plan view of one of the carriages of the lighting apparatus with the lighting cell carriers shown in a second position;

FIG. 6 is a partial perspective view of the carriage of FIG. 5 with the lighting cells shown in a third position;

FIG. 7 is a partial perspective view of the carriage of FIGS. 5 and 6 with the lighting cells shown in a fourth position and the reflector mounting bracket omitted;

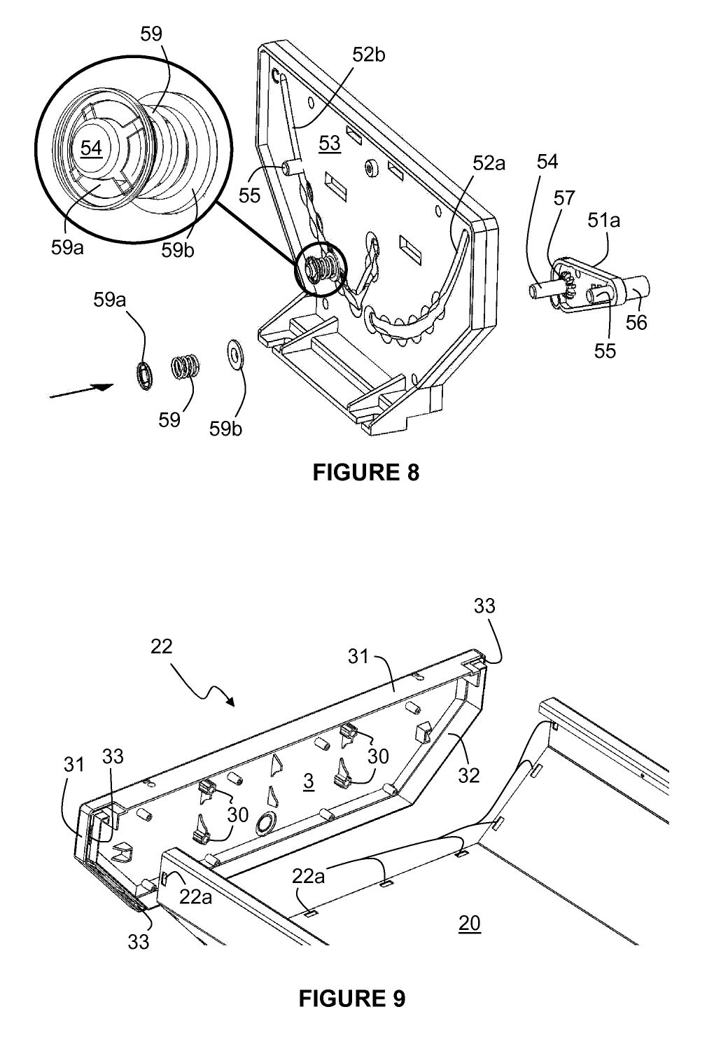

FIG. 8 is an exploded perspective view of the carriage of FIGS. 5 to 7;

FIG. 9 is an exploded perspective view of the housing showing one of the end caps separated from the channel section;

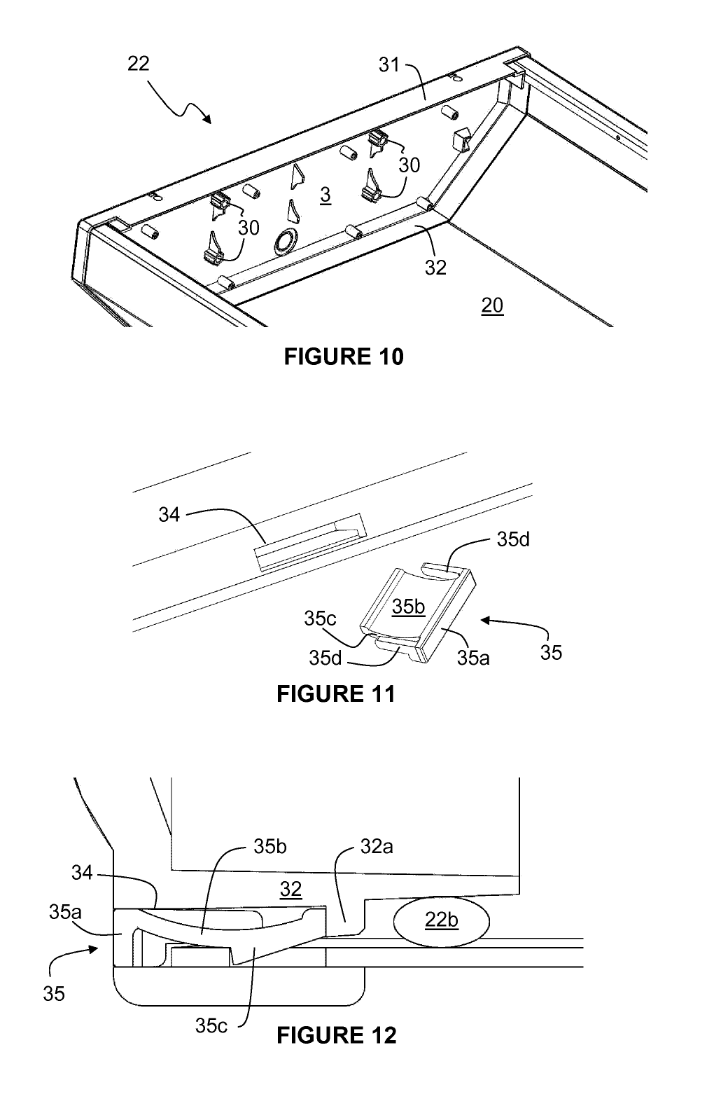

FIG. 10 is a perspective view of the housing showing the end cap assembled with the channel section;

FIG. 11 is a partial perspective view of a securing slot of the end cap with a securing clip shown about to be inserted into the slot;

FIG. 12 is a partial section view through the securing slot of the end cap and housing with the securing clip in place;

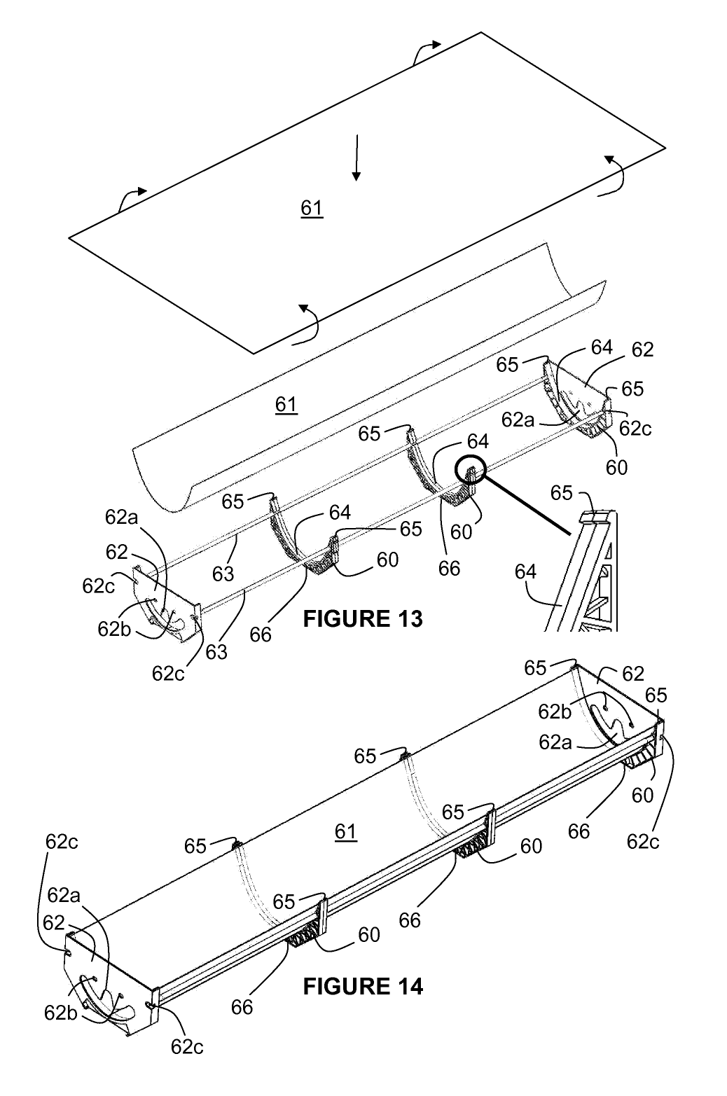

FIG. 13 is an exploded perspective schematic view showing the assembly of one of the reflector assemblies; and

FIG. 14 is a perspective view of an assembled reflector assembly.

Referring to FIGS. 1 to 3, there is shown a lighting apparatus 1 comprising a housing 2 with two end caps 3 and a dust cover 4, two pairs of parallel elongate lighting cells 5a, 5b and two concave reflectors 6 configured to focus light emitted from each pair of lighting cells 5a, 5b.

The housing 2 includes a channel member 20 of ferrous material, first and second ends 21, 22, an infrared detector 23 contained within the first end 21, a pair of lateral mounting rails 24 and a port 25 on an upper surface of the channel member 20, through which port 25 an electrical cable (not shown) extends into the first end 21. One end cap 3 is fixed to each end 21, 22 of the channel member 20 and the dust cover 4 covers the open side of the channel member 20.

Referring now to FIGS. 4 to 8, the dust cover 4 includes a clear sheet of plastics material 40 with an extrusion 41 about its peripheral edges. The extrusion 41 includes two channels 42, 43 open orthogonally to one another. A first of the channels 42 receives the sheet 40 and the second channel 43 includes a slot which receives a magnetic strip 44 that cooperates with the channel member 20 to retain the dust cover 4 over the open side of the channel member 20.

Each lighting cell 5a, 5b (only one pair of which is shown) is movable with respect to the other lighting cell 5b, 5a of the pair and with respect to the reflector 6, thereby to alter the spread and/or direction of the emitted light in use. This is achieved through the use of first and second pairs of connectors 50a, 50b to which the ends of the lighting cells 5a, 5b are connected in the normal way. Each connector 50a, 50b is incorporated within a respective carrier 51a, 51b which is independently movable along a respective guide 52a, 52b in a mounting plate 53. Thus, a first end of each lighting cell 5a, 5b is supported by a first mounting plate 53 and a second end of each lighting cell 5b, 5a is supported by a second mounting plate 53.

As shown more clearly in FIG. 8, each mounting plate 53 includes an interface part 53a with two mounting pegs 53b and one of each of the guides 52a, 52b. It will be appreciated that the guides 52a, 52b of the second mounting plate 53 substantially mirror those of the first mounting plate 53 to permit the relevant lighting cell 5a, 5b to move along a pre-determined path. One of the guides 52b includes a curved slot which substantially follows the curve of one side of the reflector 6 and a relatively straight slot which extends away from the reflector 6 to a substantially central or focal location thereof. The other guide 52a includes a curved slot which substantially follows the curve of the opposite side of the reflector 6 and terminates in a substantially central location directly below the end of the first guide 52b.

Each carrier 51a, 51b includes a flat substantially triangular body with first and second guide pegs 54, 55 on a first main face thereof and with one of the connectors 50a, 50b and an adjustment peg 56 on a second main face thereof. The first guide peg 54 includes a tapered projection 57 defined by a series of ribs at its base.

In use, the first and second guide pegs 54, 55 of each of the carriers 51a, 51b are received within a respective one of the guide slots 52a, 52b and movable therealong by gripping and moving the adjustment peg 56. Thus, the lighting cells 5a, 5b are movable between a first position in which they are side by side, as shown in FIG. 4, and a second position in which one of the lighting cells 5b is above the other lighting cell 5a, as shown in FIG. 7.

The lighting cells 5a, 5b are also configured for stepwise adjustment by virtue of the projection 57 one each of the carriers 51a, 51b, which are shaped to cooperate with and biased toward one of a plurality of cooperating portions 58 formed in the guides 52a, 52b. The cooperating portions 58 of the guides 52a, 52b are in the form of depressions 58 in the mounting plate 53 along and centred with respect to the guide slots 52a, 52b. The depressions 58 have a complementary shape to that of the projections 57 of the carriers. The projection 57 of each carrier 51a, 51b is biased toward the depression 58 by virtue of a compression spring 59 which surrounds the first guide peg 54 and is retained thereon by a starlock washer 59a and urges a flat washer 59b against a portion of the mounting plate 53 which surrounds the guide slot 52a, 52b. In order to move the carrier 51a, 51b, the user (not shown) compresses the spring 59 against the mounting plate 53, grips the adjustment peg 56, pulls the carrier 51a, 51b to the desired position and releases the spring 59 such that the projection 57 engages the relevant depression 58 in the mounting plate 53.

Referring now to FIGS. 9 to 12, each end cap 3 is substantially rectangular in plan with two chamfered corners, four threaded mounting holes 30 on its inner surface, a peripheral wall 31 and an inner U-shaped wall 32 between which walls is defined a receptacle 33. The end cap 3 also includes a plurality of openings 34 extending into the receptacle 33 and into a portion of the inner wall 32. The openings 34 are aligned with respective apertures 22a along the edge of each end 21, 22 of the housing. Each end 21, 22 of the housing 2 is received within the receptacle 33 of the end cap 3 and is secured thereto using a plurality of clips 35 which extend through the openings 34 to engage the apertures 22a as shown more clearly in FIG. 12. The end cap 3 also includes a seal 22b inserted between the inner wall 32 and the inner surface of the relevant end 21, 22 of the housing 2.

Each clip 35 includes a flat end portion 35a, a resilient curved portion 35b extending from the end portion 35a, a tapered barb portion 35c at the free end of the resilient portion 35b and a pair of wedge portions 35d extending from the flat end portion 35a on either side of the barb portion 35c. Each opening 34 has a slightly larger size and shape to that of the flat end portion 35a of the clip 35 such that when the clip 35 is fully inserted, the barb portion 35c engages the aperture 22a, the flat end portion 35a substantially covers the opening 34 and the wedge portions 35d cooperate with the sides of the opening 34 to provide an interference fit. The free end of the barb portion 35c abuts a facing portion 32a of the inner wall 32 such that the clip 35 is fully contained within the opening 34, wherein the only visible portion of the clip 35 is the flat end portion 35a which is flush with the surrounding surface of the end cap 3 and covers substantially the opening 34.

Thus, the clip 35 is configured to permanently or irreversibly engage the apertures 22a of the end portion 21, 22, wherein the end cap 3 and housing 2 may only be disengaged by damaging at least a portion of the clip 35, the end cap 3 and/or the housing 2.

During assembly, insertion of the clip 35 into the opening 34 causes the tapered surface of the barb portion 35c to contact the edge of the relevant end 21, 22 of the channel member 20 and causes the free end of the barb portion 35c to be urged against the inner wall 32. It follows that continued insertion of the clip 35 causes the resilient portion 35b to flex toward a flat condition, which consequently causes the flat end portion 35a to tilt to an angle with respect to the surrounding surface of the end cap 3. This causes the barb portion 35c to be urged against the inner surface of the end 21, 22 until the clip 35 is inserted to such an extent that the barb portion 35c aligns with the aperture 22a at which point it snaps into the aperture 22a and the flat end portion 35a becomes flush with the surrounding surface of the end cap 3.

Thus, the clip 35 also provides a clear indicator to a person assembling the kit that the clip 35 is in place. More specifically, the flat end portion 35a is only flush with the surrounding surface of the end cap 3 when the clip 35 is properly installed.

Referring now to FIGS. 13 and 14, each of the reflectors 6 includes four spaced support brackets 60, a reflective sheet 61, a pair of end plates 62 and a pair of alignment rods 63. Each bracket 60 is substantially U-shaped and includes a curved upper cradle surface 64, a flange 65 extending inwardly from each end of the cradle surface 64, a flat base 66 and an alignment hole adjacent each of its free ends. The reflective sheet 61 is formed of a resilient material, stainless steel in this embodiment. The flanges 65 of each bracket 60 engage respective portions of the longitudinal edges of the reflective sheet 61 to hold it in a flexed condition against the cradle surface 64 of that bracket 60 to provide a curved reflective surface.

Each end plate 62 includes a U-shaped aperture 62a incorporating a central slot extending from the centre of the U-shape and a pair of mounting holes 62b. The aperture 62a is configured to be aligned with the guides 52a, 52b of the mounting plate 53 when the end plate 62 is secured to the mounting pegs 53b of the mounting plate 53. Each alignment rod 63 extends through one of the alignment holes of each bracket 60 and into a hole 62c of each end plate 62. Each hole 62c of the end plates 62 is undersized relative to the alignment rods 63 to provide an interference fit therewith, thereby retaining the alignment rod 63 therein.

Thus, each reflector 6 is a standalone unit and the lighting assembly incorporates two such units side by side with the sides of their respective brackets 60 in abutment.

It will be appreciated that this arrangement provides flexibility in assembling bespoke standalone reflectors 6 for incorporation within a lighting apparatus 1. This feature in combination with the end cap 3 feature synergistically improves the ability to configure lighting apparatus 1 of various sizes and/or lengths for different applications. Both or either of these features in combination with the adjustable lighting cell 5a, 5b feature permits a very broad range of circumstances to be easily accommodated.

It will be appreciated by those skilled in the art that several variations to the embodiments described herein are envisaged without departing from the scope of the invention. It will also be appreciated that any number of combinations of the aforementioned features and/or those shown in the appended drawings provide clear advantages over the prior art and are therefore within the scope of the invention described herein.

1. A lighting apparatus comprising a first connector for connecting to and holding a first elongate lighting cell, a second connector for connecting to and holding a second elongate lighting cell and a concave reflector for focusing light emitted from lighting cells connected, in use, to the connectors, wherein the first connector is movable with respect to the second connector, thereby to alter the spread and/or direction of light emitted from lighting cells connected to and held by the connectors.

2. Apparatus according to claim 1, wherein the first connector is also movable with respect to the reflector.

3. Apparatus according to claim 1, wherein, each connector is independently movable with respect to the other and with respect to the reflector.

4. Apparatus according to claim 1, wherein the first and/or second connectors is movable, in use, between a first position in which the lighting cells are side by side, and a second position in which one of the cells is above the other.

5. Apparatus according to claim 1, wherein one of the connectors is mounted on a carrier which is movable along the guide.

6. Apparatus according to claim 1, wherein the first connector is mounted on a first carrier which is movable along a first guide and the second connector is mounted on a second carrier which is movable along a second guide.

7. Apparatus according to claim 5, wherein the or each guide is configured for stepwise adjustment of the connector or connectors.

8. Apparatus according to claim 7, wherein the connector or carrier comprises a portion shaped to cooperate with one of two or more portions of the guide to provide the stepwise adjustment.

9. Apparatus according to claim 8, wherein one of the cooperating portions comprises a projection and the other cooperating portion comprises a recess or depression.

10. Apparatus according to claim 8 further comprising a resilient biasing means configured to bias, in use, the cooperating portions toward one another.

11. Apparatus according to claim 1 further comprising a housing with an end portion, an end cap with a receptacle within which the end portion of the housing is received and a clip received within an opening of the end cap, which clip engages an engaging feature of the end portion to connect the end cap to the housing.

12. A lighting apparatus comprising a housing with an end portion, an end cap with a receptacle within which the end portion of the housing is received and a clip received within an opening of the end cap, which clip engages an engaging feature of the end portion to connect the end cap to the housing.

13. Apparatus according to claim 11, wherein the clip is configured to permanently or irreversibly engage the engaging feature of the end portion.

14. Apparatus according to claim 11, wherein the receptacle comprises an inner wall and an outer wall configured to at least partially obscure the clip when the clip is engaged with the engaging feature to prevent or at least inhibit access to or removal of the clip.

15. Apparatus according to claim 14, wherein the end portion and the engaging feature are received between the walls.

16. Apparatus according to claim 11, wherein the clip resiliently engages the engaging feature.

17. Apparatus according to claim 16, wherein the clip comprises a curved resilient portion and a projection and the engaging feature comprise a recess or aperture, the opening being configured to straighten the resilient portion, in use, upon insertion of the clip therein and to snap the projection into engagement with a recess or aperture.

18. Apparatus according to claim 11, wherein a portion of the clip is configured to be flush with a portion of the end cap which surrounds the opening when the clip is engaged with the engaging feature.

19. Apparatus according to claim 1 the reflector comprises two or more spaced reflector brackets and a resilient reflective sheet received by the brackets and having first and second major surfaces, each bracket having a concave cradle surface and a flange extending inwardly from each end of the cradle surface, wherein the flanges of each bracket engage respective portions of the longitudinal edges of the sheet to hold the sheet in a flexed condition with the first major surface thereof in abutment with the cradle surface of the respective bracket, thereby to provide a concave reflective second major surface.

20. Apparatus according to claim 18 further comprises at least one alignment member that engages both brackets.

21. Apparatus according to claim 19, wherein at least one of the brackets is located at or adjacent an end of the reflector and comprises an end plate.

22. Apparatus according to claim 20, wherein the end plate comprises a fastening or locking formation configured to cooperate with the alignment member to retain it in place.

23. Reflector according to claim 18, wherein the two or more brackets comprises three or more brackets.

24. Apparatus according to claim 1 further comprising two parallel elongate lighting cells, wherein a first of the cells is connected to the first connector and a second of the cells is connected to the second connector.

25. A kit of parts for assembly into a lighting apparatus according to claim 1.

26. A housing for use in an apparatus according to claim 11, the housing comprising an end portion with engaging means in the form of at least one recess or aperture.

27. An end cap for use in an apparatus according to claim 11, the end cap comprising a receptacle configured to receive the end portion of the housing and an opening for receiving the clip.

28. A clip for use in an apparatus according to claim 11, the clip being configured to be inserted, in use, into or through the opening of the end cap to engage the engaging feature of the end portion of the housing.

29. A reflector for use in a lighting apparatus according to claim 1, the reflector comprising two or more spaced reflector brackets and a resilient reflective sheet received by the brackets and having first and second major surfaces, each bracket having a concave cradle surface and a flange extending inwardly from each end of the cradle surface, wherein the flanges of each bracket engage respective portions of the longitudinal edges of the sheet to hold the sheet in a flexed condition with the first major surface thereof in abutment with the cradle surface of the respective bracket, thereby to provide a concave reflective second major surface.

30. A reflector comprising two or more spaced reflector brackets and a resilient reflective sheet received by the brackets and having first and second major surfaces, each bracket having a concave cradle surface and a flange extending inwardly from each end of the cradle surface, wherein the flanges of each bracket engage respective portions of the longitudinal edges of the sheet to hold the sheet in a flexed condition with the first major surface thereof in abutment with the cradle surface of the respective bracket, thereby to provide a concave reflective second major surface.
